(19) United States
(12) Patent Application Publication
(10) Pub. No.: US 2026/0106076 A1
(43) Pub. Date: Apr. 16, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Sun-Min Jung, Suwon-si (KR); Sangkyu Lee, Suwon-si (KR); Hongseok Kim, Suwon-si (KR); Chanhee Nam, Suwon-si (KR)

(73) Assignee: SAMSUNG ELECTRO-MECHANICS CO., LTD., Suwon-si (KR)

(21) Appl. No.: 19/094,278

(22) Filed: Mar. 28, 2025

(30) Foreign Application Priority Data
Oct. 16, 2024 (KR) 10-2024-0141365

(51) Int. Cl. H01G 4/12; H01G 4/30

(52) U.S. Cl. CPC H01G 4/1227; H01G 4/129; H01G 4/30

(57) ABSTRACT

A multilayer ceramic capacitor including a capacitor body including a dielectric layer and an internal electrode layer, and an external electrode disposed on an outer surface of the capacitor body, wherein the dielectric layer includes barium (Ba), titanium (Ti), and boron (B), the dielectric layer includes a plurality of dielectric grains and grain boundaries disposed between the plurality of dielectric grains, and an average thickness of the grain boundaries is about 1 nm to about 10 nm.

### CROSS-REFERENCE TO RELATED APPLICATION

This application claims priority to and the benefit of Korean Patent Application No. 10-2024-0141365 filed in the Korean Intellectual Property Office on Oct. 16, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, as the scope of use has expanded to the automotive electrical industry, securing high reliability that demonstrates stable performance even under harsh operating conditions such as high voltage and high temperature has become essential.

### SUMMARY

An embodiment provides a multilayer ceramic capacitor having excellent reliability.

Another embodiment provides a method of manufacturing a multilayer ceramic capacitor.

An embodiment provides a multilayer ceramic capacitor including a capacitor body including a dielectric layer and an internal electrode layer, and an external electrode disposed on an outer surface of the capacitor body, wherein the dielectric layer includes barium (Ba), titanium (Ti), and boron (B), the dielectric layer includes a plurality of dielectric grains and a grain boundary disposed between adjacent dielectric grains among the plurality of dielectric grains, and an average thickness of the grain boundary is about 1 nm to about 10 nm.

A standard deviation of thicknesses of the grain boundary may be about 0.1 to about 1.5 and the standard deviation may be obtained as a square root of an average of squares of deviations.

The dielectric layer may include a first dielectric layer, and a second dielectric layer, the capacitor body may include an active region including the first dielectric layer and the internal electrode layer, where the internal electrode layer is stacked on the first dielectric layer, a cover region including the second dielectric layer, where the second dielectric layer is disposed on a first surface and a second surface of the active region in a stacking direction, and a side margin region disposed on opposite side ends of the active region in a direction perpendicular to the stacking direction, wherein the boron (B) is included in at least one of the active region, the cover region, or the side margin region.

The boron (B) may be included in an amount of about 0.01 parts by atom to about 5 parts by atom based on 100 parts by atom of titanium (Ti) in the dielectric layer.

The dielectric layer may further include silicon (Si).

The silicon (Si) may be included in an amount of about 0.1 parts by atom to about 5 parts by atom based on 100 parts by atom of titanium (Ti) in the dielectric layer.

The dielectric layer may further include at least one rare earth element. The dielectric layer may further include two or more rare earth elements selected from La, Ce, Pr, Nd, Pm, Sm, Eu, Gd, Tb, Dy, Ho, Er, Tm, Yb, Lu, and Y.

The dielectric layer may further include dysprosium (Dy) and terbium (Tb).

The at least one rare earth element may be included in an amount of about 0.5 parts by atom to about 5 parts by atom based on 100 parts by atom of titanium (Ti) in the dielectric layer.

The grain boundary may include at least one selected from boron (B) and silicon (Si).

The grain boundary may include boron (B) and silicon (Si).

The grain boundary may further include at least one rare earth element.

A size of a dielectric grain among the plurality of dielectric grains may be about 100 nm to about 500 nm.

Another embodiment provides a method of manufacturing a multilayer ceramic capacitor including: mixing a barium titanate-based compound and borosilicate glass to prepare a dielectric slurry; manufacturing a plurality of dielectric green sheets from the dielectric slurry and forming a conductive paste layer on a surface of two or more dielectric green sheets among the plurality of dielectric green sheets; manufacturing a dielectric green sheet stack by stacking a plurality of the dielectric green sheets including the two or more dielectric green sheets on which the conductive paste layer is formed on which the conductive paste layer is formed; firing the dielectric green sheet stack to manufacture a capacitor body including a dielectric layer and an internal electrode layer; and forming an external electrode on a surface of the capacitor body, wherein the dielectric layer includes barium (Ba), titanium (Ti), and boron (B), the dielectric layer includes a plurality of dielectric grains and a grain boundary disposed between adjacent dielectric grains among the plurality of dielectric grains, and an average thickness of the grain boundary is about 1 nm to about 10 nm.

The borosilicate glass may include silicon dioxide (SiO₂) and boron oxide (B₂O₃).

The borosilicate glass may be mixed in an amount such that boron (B) included in the borosilicate glass may be in an amount of about 0.01 parts by mole to about 10 parts by mole based on 100 parts by mole of titanium (Ti) included in the barium titanate-based compound.

The dielectric slurry may be prepared by further mixing at least one rare earth element-containing compound.

The at least one rare earth element-containing compound may include a dysprosium (Dy)-containing compound and a terbium (Tb)-containing compound.

The dysprosium (Dy)-containing compound may include Dy₂O₃, and the terbium (Tb)-containing compound may include Tb₄O₇.

The multilayer ceramic capacitor according to an embodiment may improve reliability by having a dielectric layer that is capable of low-temperature firing, has excellent densification, and has a uniform microstructure and uniform grain boundaries.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 is a schematic view showing a dielectric layer according to an embodiment.

FIGS. 6A and 6B are TEM-EDS (transmission electron microscope-energy dispersive spectroscopy) analysis images of a dielectric layer according to Example 2.

FIGS. 7A and 7B are TEM-EDS (transmission electron microscope-energy dispersive spectroscopy) analysis images of a dielectric layer according to Example 4.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

Additionally, throughout the specification, when it is said to ‘include as a main component’, it means that among at least one component present in an area, one component has the highest content based on a total amount of components.

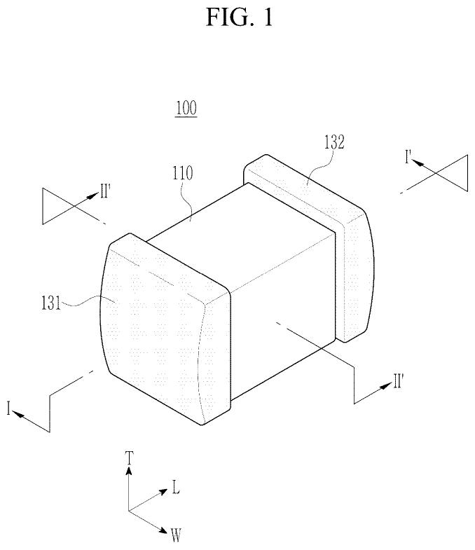

Hereinafter, a multilayer ceramic capacitor according to an embodiment will be described with reference to FIGS. 1 to 4.

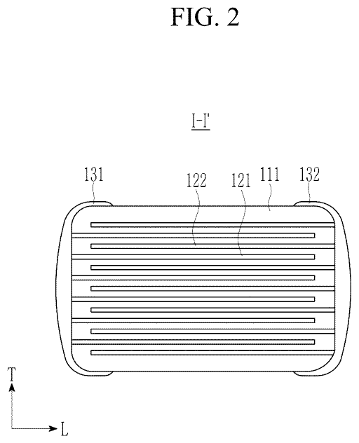

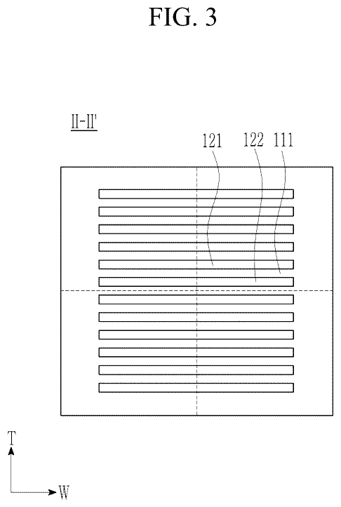

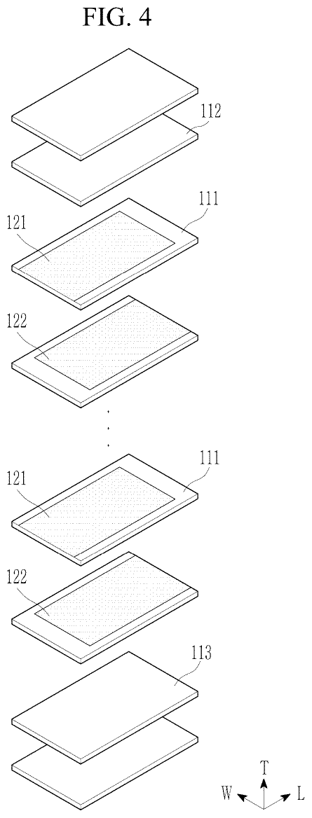

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed on an outer surface the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region 120 and cover regions 112 and 113.

The active region 120 is a region where the dielectric layer 111 and the internal electrode layers 121 and 122 are alternately stacked, which contributes to forming capacitance of the multilayer ceramic capacitor 100. Specifically, the active region 120 may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region 120, respectively.

Additionally, the capacitor body 110 may further include side margin regions.

The side margin regions are width-direction margin portions and may be positioned on opposite side ends of the active region 120 in the width direction (W-axis direction), that is, on the fifth surface and the sixth surface, respectively. The side margin regions may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin regions serve to prevent damage to the internal electrode layers 121 and 122 due to physical or chemical stress.

### Dielectric Layer

The dielectric layer 111 may include barium (Ba), titanium (Ti), and boron (B).

Boron (B) included in the dielectric layer can exist in any region of the capacitor body 110. That is, boron (B) may be included in at least one of the active region, cover regions, and side margin regions of the capacitor body 110.

When the dielectric layer 111 includes barium (Ba), titanium (Ti), and boron (B), a multilayer ceramic capacitor with excellent reliability may be secured because it is capable of low-temperature firing and has excellent densification.

The dielectric layer 111 may further include silicon (Si).

The barium (Ba) and titanium (Ti) may be constituent elements of a barium titanate compound that constitutes the main component of the dielectric layer 111.

The barium titanate-based compound is a dielectric base material, have high permittivity, and contribute to forming the permittivity of multilayer ceramic capacitors 100.

The barium titanate-based compound may be a compound including barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

Boron (B) and silicon (Si) can be derived from borosilicate glass used as a sintering agent, such as a liquid sintering agent, when forming the dielectric layer 111. The borosilicate glass may include for example silicon dioxide (SiO₂) and boron oxide (B₂O₃).

The borosilicate glass has a low softening point, and as the content of boron (B) in borosilicate glass increases, a densification rate increases and the activation energy decreases. That is, the densification may be increased by increasing the viscous flow with the low activation energy of borosilicate glass. Therefore, when forming a dielectric layer using borosilicate glass as a sintering agent, the softening temperature may be lowered to enhance sinterability and wettability with the barium titanate-based compound, thereby lowering a firing temperature and improving the densification of the dielectric layer.

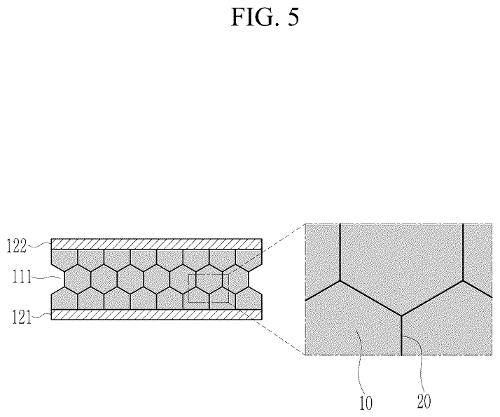

Additionally, the dielectric layer 111 may be explained with reference to FIG. 5.

FIG. 5 is a schematic view showing a dielectric layer according to an embodiment.

Referring to FIG. 5, the dielectric layer 111 may include a plurality of dielectric grains 10 and grain boundaries 20 disposed between the plurality of dielectric grains 10.

According to an embodiment, the dielectric layer 111 has a uniform microstructure and uniform grain boundaries, thereby increasing grain boundary resistance and thus ensuring a multilayer ceramic capacitor with excellent reliability. The uniform microstructure means that the size of the dielectric grains 10 is uniform throughout the region. In addition, a uniform grain boundary means that the thickness of the grain boundaries 20 is constant and uniform without agglomeration or interruption of the grain boundary.

When using borosilicate glass to form the dielectric layer, insulation properties may be secured because the band gap is higher than that of BaTiO₃. Accordingly, when a dielectric layer is formed using borosilicate glass as a sintering agent, uniform insulation properties at grain boundaries may be achieved, thereby preventing deterioration and improving reliability.

Specifically, an average thickness of the grain boundaries 20 may be about 1 nm to about 10 nm, for example about 2 nm to about 9 nm, or about 3 nm to about 8 nm. When the average thickness of the grain boundaries 20 is within the above range, a uniform microstructure and uniform grain boundary are obtained, thereby increasing grain boundary resistance and securing a multilayer ceramic capacitor with excellent reliability.

The standard deviation of the thickness of the grain boundaries 20 may be about 0.1 to about 1.5, for example, about 0.2 to about 1.4, about 0.3 to about 1.3, or about 0.4 to about 1.2. When the standard deviation of the thickness of the grain boundaries 20 is within the above range, a multilayer ceramic capacitor having a uniform microstructure and uniform grain boundary may be secured with increased grain boundary resistance and excellent reliability.

The standard deviation (σ) of the thickness of a grain boundary can be obtained by dividing the squares of the thickness deviations by the number of measurements and taking the square root of the sum, i.e., the square root of the average of the squares of the thickness deviations, as in Equation 1.

$$σ = \sqrt{\frac{1}{n} {\sum }_{i = 1}^{n} {( {x}_{i} - \overline{x} )}^{2}} \qquad [ Equation 1 ]$$

The average thickness and standard deviation of the thickness of the grain boundaries 20 may be obtained by TEM-EDS (transmission electron microscope-energy dispersive spectroscopy) analysis. Other methods and/or tools appreciated by one of ordinary skill in the art, even if not described in the present disclosure, may also be used.

In more detail, after the multilayer ceramic capacitor 100 was placed into an epoxy mixing solution and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample may be measured using a transmission electron microscope (TEM) so that at least one dielectric layer and at least one internal electrode layer are visible. For example, when the active region of a cross-sectional sample is divided into three portions, the upper portion, the middle portion, and the lower portion, it can be measured by TEM so that at least one dielectric layer and at least one internal electrode layer are visible in each region. TEM may be measured under conditions of an acceleration voltage of 200 kV using a Xe-FIB (focused ion beam). Next, EDS (Energy Dispersive Spectroscopy) analysis is performed on the dielectric layer in the TEM image of the measured cross-sectional sample to confirm the structure of the dielectric grains 10 and grain boundaries 20 and to measure the average thickness and standard deviation of the thickness of the grain boundaries 20.

Specifically, the shape of the grain boundaries 20 can be confirmed through mapping of the silicon (Si) element, which is easily detectable by EDS among the boron (B) and silicon (Si) elements, and the average thickness and standard deviation of the thickness of the grain boundaries 20 can be measured. For example, when the active region of a cross-sectional sample is divided into three portions, the upper portion, the middle portion, and the lower portion, at least four points are taken from the grain boundaries 20 within the dielectric layer for each region, and the average thickness of the grain boundaries may be obtained as the average value of the thicknesses at at least 12 points in total, and the standard deviation of the thicknesses at the at least 12 points may be obtained.

Boron (B) may be included in the dielectric layer 111 in an amount of about 0.01 parts by atom to about 5 parts by atom, for example about 0.05 parts by atom to about 4.8 parts by atom, about 0.06 parts by atom to about 4.5 parts by atom, or about 0.1 parts by atom to about 4.0 parts by atom based on 100 parts by atom of titanium (Ti). When boron (B) is included in the dielectric layer within the above content range, low-temperature firing may be possible and excellent density is achieved, and a uniform microstructure and uniform grain boundaries are achieved, so that the reliability of the multilayer ceramic capacitor may be improved as grain boundary resistance increases.

Silicon (Si) may be included in the dielectric layer 111 in an amount of about 0.1 parts by atom to about 5 parts by atom, for example about 0.5 parts by atom to about 4.5 parts by atom, or about 1 part by atom to about 4 parts by atom based on 100 parts by atom of titanium (Ti). When silicon (Si) is included in the dielectric layer within the above content range, the reliability of the multilayer ceramic capacitor can be improved because it has low-temperature firing, excellent density, and uniform microstructure and uniform grain boundaries.

The dielectric layer 111 may further include at least one rare earth element.

The rare earth element may include La, Ce, Pr, Nd, Pm, Sm, Eu, Gd, Tb, Dy, Ho, Er, Tm, Yb, Lu, Y, and the like, and for example may include dysprosium (Dy) and terbium (Tb), but is not limited thereto.

The rare earth element may be included in an amount of about 0.5 parts by atom to about 5 parts by atom based on 100 parts by atom of titanium (Ti) in the dielectric layer 111, for example, about 1 part by atom to about 4.8 parts by atom, about 1.5 parts by atom to about 4.5 parts by atom, or about 2 parts by atom to about 4 parts by atom. When the rare earth element is included in the dielectric layer within the content ranges, reliability of the multilayer ceramic capacitor may be improved.

Specifically, the grain boundaries 20 in the dielectric layer 111 may include at least one selected from boron (B) and silicon (Si), for example, both boron (B) and silicon (Si). If at least one of boron (B) and silicon (Si) is present in the grain boundaries 20, reliability of the multilayer ceramic capacitor may be improved due to uniform microstructure and uniform grain boundaries as well as low temperature firing and excellent densification.

In addition, the grain boundaries 20 may further include at least one rare earth element. For example, dysprosium (Dy) and terbium (Tb) may be included therein but is not limited thereto.

The components and contents thereof present in the dielectric layer 111 can be obtained by TEM-EDS (transmission electron microscope-energy dispersive spectroscopy) analysis or ICP-OES (inductively coupled plasma-optical spectroscopy) analysis. Other methods and/or tools appreciated by one of ordinary skill in the art, even if not described in the present disclosure, may also be used.

The TEM-EDS analysis may be the same method as above. The TEM image of the cross-sectional sample may be subjected to an EDS analysis of the dielectric layer to detect boron (B), silicon (Si), rare earth element, and the like and obtain contents thereof. For example, the element contents may be obtained by dividing the active region of the cross-sectional sample into three portions such as upper, middle, and lower portions and then, taking three points within the dielectric layer per each portion and then, averaging the nine measurements in total.

An ICP-OES analysis may be performed, after obtaining a sample by dissolving the dielectric layer of the multilayer ceramic capacitor in a mixed solution of hydrofluoric acid and nitric acid and about 500 times diluting it, by using AVIO500 (Perkin Elmer Inc.), for example, under conditions of a plasma gas flow of 12 L/min and plasma RF power of 1400 W.

For example, because boron (B), of which the element number is 5, may be difficult to detect in the EDS analysis, its element content may be measured through the ICP-OES analysis.

The dielectric grain 10 may have a size of about 100 nm to about 500 nm, for example, about 120 nm to about 480 nm, about 150 nm to about 450 nm, about 180 nm to about 420 nm, or about 200 nm to about 400 nm. The size of the dielectric grain may be an average of the diameter of the longest axis and the diameter of the shortest axis.

The size of the dielectric grain 10 may be measured through SEM (scanning electron microscope) analysis. Other methods and/or tools appreciated by one of ordinary skill in the art, even if not described in the present disclosure, may also be used.

In more detail, after the multilayer ceramic capacitor 100 was placed into an epoxy mixing solution and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Subsequently, the active region of the cross-sectional sample may be measured by SEM, so that at least one dielectric layer and at least one internal electrode layer may be visible. SEM may be measured under conditions of an accelerating voltage of about 2 kV. In the obtained SEM image, the grain size may be measured. For example, after dividing the active region of the cross-sectional sample into three portions such as upper, central, and lower portions, an area of about 5 μm×5 about μm (width×length) is taken from each portion to measure a grain size in the dielectric layer and then, averaged. Herein, a size of one dielectric grain may be an average of the diameter of the longest axis and the diameter of the shortest axis.

An average thickness (an average length in a T-axis direction) of the dielectric layer 111 may be about 0.1 μm to about 8.0 μm, for example, about 0.1 μm to about 6.0 μm. If the dielectric layer 111 has an average thickness within the ranges, the multilayer ceramic capacitor may exhibit excellent reliability.

The average thickness of the dielectric layer 111 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermo Fisher Scientific, with measurement conditions of 10 kV and 0.2 nA, an analysis magnification of 100 times, and may be measured for at least 1 layer, 3 layers, 5 layers, or 10 layers or more of dielectric layers 111. In a scanning electron microscope (SEM) image of a measured cross-sectional sample, the central point in the length direction (L-axis direction) or the width direction (W-axis direction) of the dielectric layer 111 is used as a reference point, and the arithmetic mean value of the thickness of the dielectric layer 111 at 10 points spaced apart from the reference point by a predetermined interval can be obtained. The intervals of the 10 points may be adjusted depending on the scale of the scanning electron microscope (SEM) image, and may be, for example, about 1 μm to about 100 μm, about 1 μm to about 50 μm, or about 1 μm to about 10 μm. At this time, all 10 points should be positioned within the dielectric layer 111, and if all 10 points are not positioned within the dielectric layer 111, the position of the reference point may be changed, or the interval between the 10 points may be adjusted.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 includes a conductive metal, and may include at least one selected from among metals such as Ni, Cu, Ag, Pd, Au, and an alloy thereof.

Additionally, the internal electrode layers 121 and 122 may include dielectric particles having the same composition as the ceramic material included in the dielectric layer 111.

The internal electrode layers 121 and 122 may be formed using a conductive paste including a conductive metal. The printing method for the conductive paste may be either screen printing or gravure printing.

An average thickness of the internal electrode layers 121 and 122 may be about 0.1 μm to about 2 μm.

The average thickness of the internal electrode layers 121 and 122 may be measured by scanning electron microscope (SEM) analysis. Specifically, in the scanning electron microscope (SEM) image of the cross-sectional sample obtained by the same method as the method for measuring the average thickness of the dielectric layer 111, the central point in the length direction (L-axis direction) or the width direction (W-axis direction) of the internal electrode layers 121 and 122 is used as a reference point, and the arithmetic mean value of the thickness of the internal electrode layers 121 and 122 at 10 points spaced apart from the reference point by a predetermined interval can be obtained. The intervals of the 10 points may be adjusted depending on the scale of the scanning electron microscope (SEM) image, and may be, for example, about 1 μm to about 100 μm, about 1 μm to about 50 μm, or about 1 μm to about 10 μm. At this time, all 10 points should be positioned within the internal electrode layers 121 and 122, and if all 10 points are not positioned within the internal electrode layers 121 and 122, the location of the reference point can be changed or the interval between the 10 points can be adjusted.

The capacitor body 110 may be formed by firing a stacking structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from silicon oxide, boron oxide, aluminum oxide, transition metal oxide, alkali metal oxide, and alkaline earth metal oxide. The transition metal may be selected from zinc (Zn), titanium (Ti), copper (Cu), vanadium (V), manganese (Mn), iron (Fe) and nickel (Ni), the alkali metal may be selected from lithium (Li), sodium (Na) and potassium (K), and the alkaline-earth metal may be at least one selected from magnesium (Mg), calcium (Ca), strontium (Sr), and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outer surface the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outer surface, heat resistance, and equivalent series resistance (ESR) of the multilayer capacitor 100.

### Method for Manufacturing Multilayer Ceramic Capacitor

Hereinafter, a method of manufacturing the multilayer ceramic capacitor 100 according to an embodiment will be described.

A multilayer ceramic capacitor 100 according to an embodiment may be manufactured by mixing a barium titanate-based compound and borosilicate glass to prepare a dielectric slurry; manufacturing a dielectric green sheet using the dielectric slurry and forming a conductive paste layer on the surface of the dielectric green sheet; manufacturing a dielectric green sheet stack by stacking the dielectric green sheet on which the conductive paste layer is formed; firing the dielectric green sheet stack to manufacture a capacitor body including a dielectric layer and an internal electrode layer; and forming an external electrode on one surface of the capacitor body.

The barium titanate-based compound is a compound including barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The borosilicate glass may be used as a liquid sintering agent.

The borosilicate glass may include silicon dioxide (SiO₂) and boron oxide (B₂O₃). In other words, the borosilicate glass may include silicon (Si) and boron (B) elements.

By using the borosilicate glass, the softening temperature is lowered, thereby enhancing sinterability and wettability with the barium titanate-based compound, and lowering the firing temperature and forming a dielectric layer with improved densification.

The borosilicate glass may be mixed in an amount such that boron (B) included in the borosilicate glass may be about 0.01 parts by mole to about 10 parts by mole based on 100 parts by mole of titanium (Ti) included in the barium titanate-based compound. For example, the borosilicate glass may be mixed in an amount such that boron (B) may be about 0.05 parts by mole to about 9 parts by mole, or about 0.1 parts by mole to about 8 parts by mole, based on 100 parts by mole of titanium (Ti). When the borosilicate glass is mixed in the above content range, the reliability of the multilayer ceramic capacitor may be improved by forming a dielectric layer having a uniform microstructure and uniform grain boundaries as well as low-temperature firing and excellent densification.

The dielectric slurry may be prepared by further mixing at least one rare earth element-containing compound.

The rare earth element-containing compound may be a compound including a rare earth element such as La, Ce, Pr, Nd, Pm, Sm, Eu, Gd, Tb, Dy, Ho, Er, Tm, Yb, Lu, Y, and may include, for example, a dysprosium (Dy)-containing compound and a terbium (Tb)-containing compound.

The rare earth element-containing compound may be mixed in an amount of about 0.5 parts by mole to about 5 parts by mole, for example about 1 part by mole to about 4 parts by mole based on 100 parts by mole of the barium titanate-based compound. When the rare earth element-containing compound is mixed within the above content range, a multilayer ceramic capacitor having excellent reliability may be obtained.

The rare earth element-containing compound may be an oxide, a nitride, a salt compound of the rare earth element, or a compound in the form of a sol dispersed in an organic solvent.

The dielectric slurry may be prepared by additionally mixing additives such as a dispersant, a binder, a plasticizer, a lubricant, an antistatic agent, and a solvent.

The dispersant may include for example a phosphoric acid ester-based dispersant, a polycarboxylic acid-based dispersant, or a combination thereof. The dispersant may be mixed in an amount of about 0.1 part by weight to about 5 parts by weight, for example, about 0.3 parts by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyl resin, a polyvinyl acetal resin, an ethyl cellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

On order to form a conductive paste layer that becomes an internal electrode layer after firing, a conductive paste may be prepared by mixing a conductive powder made of a conductive metal or an alloy thereof, a binder, and a solvent. Additionally, barium titanate powder may be mixed in as a co-material if necessary. The co-material can act to inhibit the sintering of the conductive powder during the sintering process. In the manufacturing of the dielectric green sheet, a dielectric slurry may be prepared by mixing a barium titanate-based compound as a main component powder and optionally a subcomponent powder.

The conductive powder may include nickel (Ni) or a nickel (Ni) alloy.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is disposed on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 hour to about 8 hours, for example, about 1 hour to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethyl cellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and fired at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethyl cellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outer surface of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 6

A BaTiO₃ compound was prepared by mixing BaCO₃ powder and TiO₂ powder (to have a Ba/Ti mole ratio of 1.0067). The prepared BaTiO₃ compound was mixed with borosilicate glass containing SiO₂ and B₂O₃, and Dy₂O₃ and Tb₄O₇ to prepare a dielectric slurry. Herein, the borosilicate glass was mixed so that B contained in the borosilicate glass had each content shown in Table 1 based on 100 parts by mole of Ti. In addition, Dy₂O₃ and Tb₄O₇ were mixed in each amount of 1 part by mole and 0.05 parts by mole based on 100 parts by mole of the BaTiO₃ compound.

In preparing the dielectric slurry, the mixing was performed through mechanical milling by using zirconia (ZrO₂) balls as a dispersive medium after adding ethanol/toluene, a wetting dispersant, and a polyvinyl butyral (PVB) resin as a binder together.

The prepared dielectric slurry was used to manufacture a dielectric green sheet by using a head discharge type on-roll forming coater.

On the surface of the dielectric green sheet, a conductive paste layer including nickel (Ni) was printed and then, another dielectric green sheet having another conductive paste layer was stacked thereon and then, compressed to manufacture a dielectric green sheet stack.

The dielectric green sheet stack was calcinated at 400° C. or less under a nitrogen atmosphere and fired at 1300° C. or less at a hydrogen (H₂) concentration of 1.0% or less.

Subsequently, a multilayer ceramic capacitor was manufactured through processes of an external electrode, plating, or the like.

### Comparative Example 1

A multilayer ceramic capacitor was manufactured in the same manner as in Example 1 except that the borosilicate glass was not used in Example 1.

In Table 1, the B content was expressed based on 100 parts by mole of Ti.

TABLE 1

| | B content (parts by mole) |
|---|---|
| Example 1 | 0.1 |
| Example 2 | 0.5 |
| Example 3 | 1 |
| Example 4 | 3 |
| Example 5 | 5 |
| Example 6 | 7 |
| Comparative Example 1 | 0 |

### Evaluation 1: ICP-OES Analysis

The dielectric layers of the multilayer ceramic capacitors according to Examples 1 to 6 and Comparative Example 1 were subjected to ICP-OES (inductively coupled plasma-optical spectroscopy) analysis to measure each content of detected elements, and the results are shown in Table 2.

The dielectric layers were respectively dissolved in a mixed solution of hydrofluoric acid and nitric acid and then, about 500 times diluted to obtain samples, which were measured by using a device of AVIO500 (PerkinElmer Inc.) under conditions of a plasma gas flow of 12 L/min and plasma RF power of 1400 W.

In Table 2, the content of each element was expressed based on 100 parts by atom of Ti.

TABLE 2

| | Ti | Ba | Dy | Tb | Si | B |
|---|---|---|---|---|---|---|
| | (parts by | (parts by | (parts by | (parts by | (parts by | (parts by |
| | atom) | atom) | atom) | atom) | atom) | atom) |
| Example 1 | 100.00 | 100.67 | 1.80 | 0.21 | 1.42 | 0.07 |
| Example 2 | 100.00 | 100.67 | 1.90 | 0.18 | 1.61 | 0.35 |
| Example 3 | 100.00 | 100.67 | 2.00 | 0.15 | 1.48 | 0.70 |
| Example 4 | 100.00 | 100.67 | 2.10 | 0.21 | 1.53 | 2.08 |
| Example 5 | 100.00 | 100.67 | 2.00 | 0.22 | 1.62 | 3.48 |
| Example 6 | 100.00 | 100.67 | 2.20 | 0.20 | 1.51 | 5.00 |
| Comparative | 100.00 | 100.67 | 2.00 | 0.17 | 1.50 | 0.00 |
| Example 1 | | | | | | |

Referring to Table 2, the dielectric layers of Examples 1 to 6 formed by using the borosilicate glass all included Ba, Ti, and B elements, wherein the B element was included in a content of 0.01 parts by atom to 5 parts by atom based on 100 parts by atom of Ti. On the contrary, in the dielectric layer of Comparative Example 1 formed by not using the borosilicate glass, the B element was not detected.

### Evaluation 2: TEM-EDS Analysis

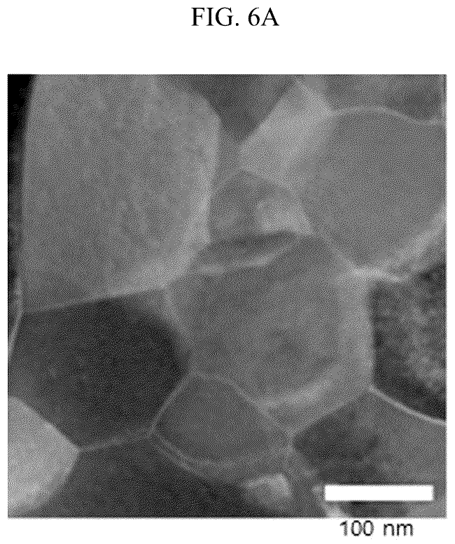

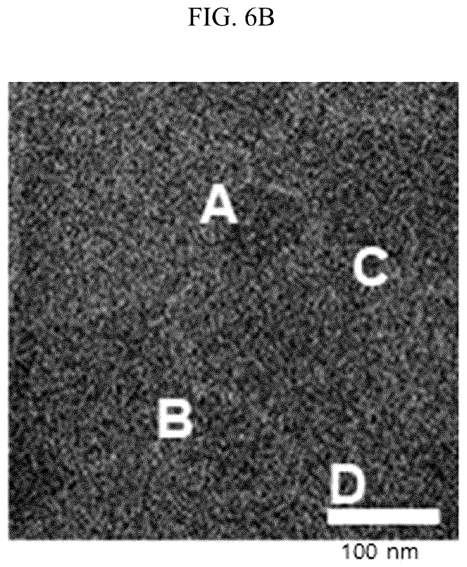

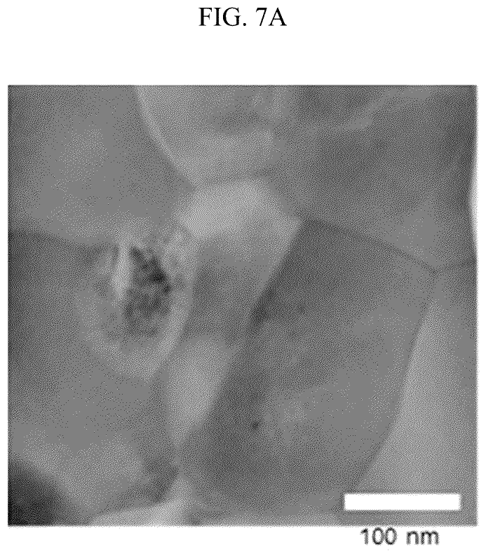

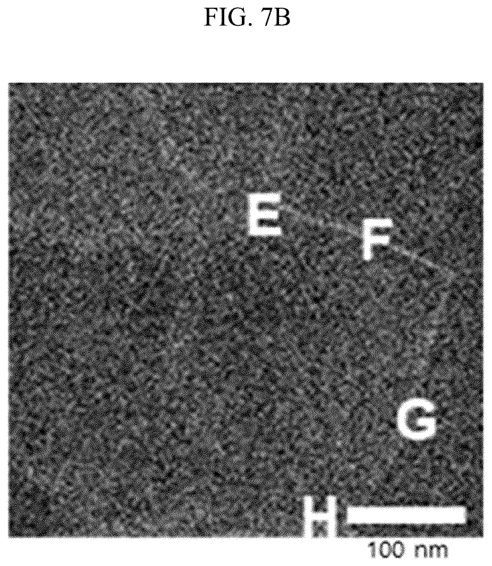

The multilayer ceramic capacitors of Examples 2 and 4 were respectively subjected to TEM-EDS (transmission electron microscope-energy dispersive spectroscopy) analysis in the following method to measure an average thickness of grain boundaries and a standard deviation of the thickness, and the results are shown in FIGS. 6 and 7 and Table 3.

Each multilayer ceramic capacitor was placed into an epoxy mixing solution and cured, and the W-axis and T-axis direction surface (WT surface) of each capacitor body was polished to a depth of ½ in the L-axis direction and then, fixed and maintained in a vacuum atmosphere chamber to obtain cross-sectional samples to observe an active region where a dielectric layer and an internal electrode layer intersect each other. Subsequently, when the active region of a cross-sectional sample was divided into three portions such as upper, middle, and lower portions, each portion was taken a TEM image of, so that at least one dielectric layer and at least one internal electrode layer were visible. TEM was measured by using Xe-FIB (focused ion beam) at an accelerated voltage of 200 kV. Subsequently, the TEM image of the cross-sectional sample was subjected to EDS (energy dispersive spectroscopy) analysis of the dielectric layers to identify a structure of dielectric grains and grain boundaries through mapping of silicon (Si) elements and measure an average thickness of the grain boundaries. The average thickness was obtained by dividing the active region of the cross-sectional sample into three portions such as upper, central, and lower portions to take four points at the grain boundaries within the dielectric layer from each portion and then, calculating an average of the twelve measurements in total and a standard deviation of the thickness at the 12 points. The standard deviation was obtained as a square root of an average of squares of the deviations.

FIGS. 6A and 6B are TEM-EDS (transmission electron microscope-energy dispersive spectroscopy) analysis images of a dielectric layer according to Example 2, and FIGS. 7A and 7B are TEM-EDS (transmission electron microscope-energy dispersive spectroscopy) analysis images of a dielectric layer according to Example 4.

FIGS. 6A to 7B show the structure of the dielectric grains and the grain boundaries present within the dielectric layer in the central portion of the active region through the Si element mapping of Examples 2 and 4, in which the four points were marked to obtain the average thickness of the grain boundaries.

TABLE 3

| | | Thickness of | Average | Standard |
|---|---|---|---|---|
| | Measurement | grain boundary | thickness | deviation of |
| | position | (nm) | (nm) | thickness |
| Example 2 | A | 1.5 | 3.58 | 1.04 |
| | B | 3.2 | | |
| | C | 2.6 | | |
| | D | 7.0 | | |
| Example 4 | E | 5.5 | 6.58 | 0.54 |
| | F | 7.8 | | |
| | G | 8.6 | | |
| | H | 4.4 | | |

Referring to Table 3, Example 2 had 3.58 nm of the average thickness of the grain boundaries and 1.04 of the standard deviation of the thickness, and Example 4 had 6.58 nm of the average thickness of the grain boundaries and 0.54 of the standard deviation of the thickness. Accordingly, the dielectric layer according to an embodiment had continuous and uniform grain boundaries with a predetermined thickness.

### Evaluation 3: Sintered Body Characteristics

When the multilayer ceramic capacitors according to Examples 1 to 6 and Comparative Example 1 were manufactured, their sintered bodies were measured with respect to a densification initiation temperature and a sintering density in the following method, and the results are shown in Table 4. The sintered bodies were structures obtained after sintering the dielectric green sheet stacks.

The densification initial temperature was obtained as a firing initiation temperature at which density was realized by measuring density according to a firing temperature of the sintered bodies.

The sintering density indicates density of the sintered bodies.

Referring to Table 4, Examples 1 to 6 exhibited a lower densification initiation temperature and a higher sintering density than Comparative Example 1.

### Evaluation 4: Reliability

The multilayer ceramic capacitors according to Examples 1 to 6 and Comparative Example 1 were measured with respect to MTTF (mean time to failure) in the following method, and the results are shown in Table 4.

The mean time to failure (MTTF) (hr) was measured under conditions of 10 hours by measuring Step IR and apply a voltage of 50 V per 1 μm of a thickness of the dielectric layer at 150° C.

In Table 4, MTTF was expressed as a ratio based on the numerical result of Example 2.

Referring to Table 4, Examples 1 to 6 exhibited excellent reliability, compared with Comparative Example 1. Accordingly, the multilayer ceramic capacitors had a dielectric layer capable of low-temperature firing and having excellent densification according to an embodiment, resultantly exhibiting improved reliability.

TABLE 4

| | Densification | | | IR |
|---|---|---|---|---|
| | initiation | Sintering | | (insulation |
| | temperature | density | | resistance) |
| | (° C.) | (g/cm³) | MTTF | (ohm) |
| Example 1 | 1160 | 4.96 | 0.91 | 10^{7.0} |
| Example 2 | 1160 | 5.02 | 1.00 | 10^{7.1} |
| Example 3 | 1150 | 5.62 | 1.22 | 10^{7.0} |
| Example 4 | 1140 | 5.74 | 1.57 | 10^{6.9} |
| Example 5 | 1130 | 5.91 | 1.35 | 10^{6.8} |
| Example 6 | 1120 | 5.94 | 1.15 | 10^{6.8} |
| Comparative Example 1 | 1190 | 4.89 | 0.73 | 10^{7.1} |

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the dielectric layer includes barium (Ba), titanium (Ti), and boron (B),
the dielectric layer includes a plurality of dielectric grains and a grain boundary disposed between adjacent dielectric grains among the plurality of dielectric grains, and
an average thickness of the grain boundary is 1 nm to 10 nm.

2. The multilayer ceramic capacitor of claim 1, wherein
a standard deviation of thicknesses of the grain boundary is 0.1 to 1.5, and
the standard deviation is obtained as a square root of an average of squares of deviations.

3. The multilayer ceramic capacitor of claim 1, wherein
the dielectric layer includes a first dielectric layer, and a second dielectric layer,
the capacitor body includes
an active region including the first dielectric layer and the internal electrode layer, where the internal electrode layer is stacked on the first dielectric layer,
a cover region including the second dielectric layer, where the second dielectric layer is disposed on a first surface and a second surface of the active region in a stacking direction, and
a side margin region disposed on opposite side ends of the active region in a direction perpendicular to the stacking direction, and
the boron (B) is included in at least one of the active region, the cover region, or the side margin region.

4. The multilayer ceramic capacitor of claim 1, wherein
the boron (B) is included in an amount of 0.01 parts by atom to 5 parts by atom based on 100 parts by atom of titanium (Ti) in the dielectric layer.

5. The multilayer ceramic capacitor of claim 1, wherein
the dielectric layer further includes silicon (Si).

6. The multilayer ceramic capacitor of claim 5, wherein
the silicon (Si) is included in an amount of 0.1 parts by atom to 5 parts by atom based on 100 parts by atom of titanium (Ti) in the dielectric layer.

7. The multilayer ceramic capacitor of claim 1, wherein
the dielectric layer further includes at least one rare earth element.

8. The multilayer ceramic capacitor of claim 1, wherein
the dielectric layer further includes two or more rare earth elements selected from La, Ce, Pr, Nd, Pm, Sm, Eu, Gd, Tb, Dy, Ho, Er, Tm, Yb, Lu, and Y.

9. The multilayer ceramic capacitor of claim 1, wherein
the dielectric layer further includes dysprosium (Dy) and terbium (Tb).

10. The multilayer ceramic capacitor of claim 7, wherein
the at least one rare earth element is included in an amount of 0.5 parts by atom to 5 parts by atom based on 100 parts by atom of titanium (Ti) in the dielectric layer.

11. The multilayer ceramic capacitor of claim 1, wherein
the grain boundary includes at least one selected from boron (B) and silicon (Si).

12. The multilayer ceramic capacitor of claim 1, wherein
the grain boundary includes boron (B) and silicon (Si).

13. The multilayer ceramic capacitor of claim 11, wherein
the grain boundary further includes at least one rare earth element.

14. The multilayer ceramic capacitor of claim 1, wherein
a size of a dielectric grain among the plurality of dielectric grains is 100 nm to 500 nm.

15. A method of manufacturing a multilayer ceramic capacitor, comprising
mixing a barium titanate-based compound and borosilicate glass to prepare a dielectric slurry;
manufacturing a plurality of dielectric green sheets from the dielectric slurry and forming a conductive paste layer on a surface of two or more dielectric green sheets among the plurality of dielectric green sheets;
manufacturing a dielectric green sheet stack by stacking the plurality of the dielectric green sheets including the two or more dielectric green sheets on which the conductive paste layer is formed;
firing the dielectric green sheet stack to manufacture a capacitor body including a dielectric layer and an internal electrode layer; and
forming an external electrode on a surface of the capacitor body,
wherein the dielectric layer includes barium (Ba), titanium (Ti), and boron (B),
the dielectric layer includes a plurality of dielectric grains and a grain boundary disposed between adjacent dielectric grains among the plurality of dielectric grains, and an average thickness of the grain boundary is 1 nm to 10 nm.

16. The method of claim 15, wherein
the borosilicate glass includes silicon dioxide (SiO₂) and boron oxide (B₂O₃).

17. The method of claim 15, wherein
the borosilicate glass is mixed in an amount such that boron (B) included in the borosilicate glass is in an amount of 0.01 parts by mole to 10 parts by mole based on 100 parts by mole of titanium (Ti) included in the barium titanate-based compound.

18. The method of claim 15, wherein
the dielectric slurry is prepared by further mixing at least one rare earth element-containing compound.

19. The method of claim 18, wherein
the at least one rare earth element-containing compound includes a dysprosium (Dy)-containing compound and a terbium (Tb)-containing compound.

20. The method of claim 19, wherein
the dysprosium (Dy)-containing compound include Dy₂O₃, and
the terbium (Tb)-containing compound includes Tb₄O₇.
